(19) United States
(12) Patent Application Publication
(10) Pub. No.: US 2006/0038818 A1
(43) Pub. Date: Feb. 23, 2006

(54) Multimedia racing experience system and corresponding experience based displays

(76) Inventor: Robert C. Steele, Fairfax, VA (US)

Correspondence Address: ZITO TLP, 26005 RIDGE ROAD, SUITE 203, DAMASCUS, MD, 20872, US

(21) Appl. No.: 11/239,188

(22) Filed: Sep. 29, 2005

Related U.S. Application Data
(62) Division of application No. 10/278,139, filed on Oct. 22, 2002.

(51) Int. Cl. G06T 11/20

(52) U.S. Cl. 345/440

(57) ABSTRACT

A methodology and user interface for viewing a racing experience presentation are provided. A method is provided for viewing driving performance data obtained as a driver travels a driving course. A method is also provided for comparing driving performance data from separate traversals of a driving course. Additionally, a user interface is provided to facilitate review of driving performance data.

### CROSS-REFERENCED APPLICATIONS

This application claims priority under 35 U.S.C. § 119(e) from U.S. Provisional Patent Application Ser. No. 60/333,499, titled “Multimedia Racing Experience System,” filed Nov. 28, 2001, the entirety of which is incorporated herein by reference.

### FIELD OF THE INVENTION

The present invention relates to a multimedia racing experience system.

### BACKGROUND OF THE INVENTION

Automotive racing is one of the most rapidly growing sports in America today and around the world. Fans relate to automotive racing because of the precision driving at high rates of speed. Automotive racing is also exciting to watch both in person or on television. The growth of automotive racing is also reflected in previous efforts to enhance the racing experience.

Some previous work focused on auto race monitoring systems. One previous system provides a race track with a ground positioning system, including at least three transmitters, transmitting signals to be received by at least a pair of receivers in each racecar racing. The receivers instantaneously determine their position and, accordingly, the exact position of the racecar upon the racetrack. This information, along with parameters such as vehicle speed, engine temperature and oil pressure, are sent by a transmitter to a receiver interconnected with a main frame computer, which uses such information to replicate each of the vehicles in a given race in real-time. The replicated information is made available to the Internet and the audio/video receivers connected thereto.

Other work has focused on simulating the experience within the vehicle. One previous simulator is a reactive ride simulator, including a package of sensors along with a telemetry radio transmitter and or recorder. This package is carried at a movable remote site, such as an actual vehicle. A radio receiver, or a player for the recorded data from the remote site, is interfaced with a decoder providing electronic signals, which include a replication of the sights, sounds and motions experienced at the remote site. A motion base is used to provide the accelerations necessary to replicate the G-forces experienced at the remote site, while a cabin on this motion base is associated with audio and visual presentation devices, so that a passenger on the reactive ride simulator also receives the audio and visual sensations of being at the remote site.

Another previous type of auto race monitoring system allows for sensing, recording and selectively displaying data associated with operational characteristics of a vehicle and an associated engine. The system includes a plurality of transducers delivering signals corresponding to such operational characteristics to a programmable logic device. These signals are converted to appropriate information signals, which are stored in an associated storage device and can be selectively displayed on a suitable display device.

Still another previous auto race monitoring system allows for controllably sensing, recording and selectively displaying data associated with operational characteristics of a vehicle. A plurality of transducers are connected to a programmable logic device along with data entry, data storage and data display devices. Information received from the transducers is processed by the logic device to determine whether a certain operational characteristic has occurred during the time that certain other characteristics are present. In addition, the amount of time that the particular characteristic occurs is determined.

Another previous type of simulator system is adaptable to an actual craft or existing simulator. The system comprises computer hardware and software capable of simulation, combinations of simulations and networked simulations. Computer inputs come from sensors attached on or near control and operation members. Computer output is sent to overlay displays and other components. Visual, audio and motion cuing systems are added to increase realism where appropriate to the simulation.

Another previous racecar monitoring system provides a vehicle data recording system which has connections to one or more analog sensors, and stores data from the sensors in a memory during laps of a track. The system provides for analog to digital conversion for converting analog data from the sensors into digital data, and triggers a procedure for storing of the data in memory. Periods of storing of the data in memory are automatically started and stopped. The system stores in memory a set of data for a datum period, and has means for storing further sets of data in a memory. A set of data stored during a first period is compared with a set of data stored during a further period and one of the sets of data is selected for retention in memory in accordance with a predetermined algorithm. The retained set of data is compared with the datum set and the selected set is output.

Although this previous work provides useful systems for simulating or receiving information from a vehicle or craft, none make use of a combination of technology and technical media, as described herein, to produce a fully automated event-driven multimedia production and delivery system, capturing the experience of a rider in a vehicle or craft. What is needed is an event-driven, multimedia system and methodology that provides a more stimulating way of re-experiencing riding in a vehicle such as a racecar or other craft. The system and methodology should capture the full breadth of the racing experience, including video, audio, vehicle telemetry, and driver biotelemetry information during the ride. Additionally, the system and methodology should incorporate both on-vehicle and remote information as part of the ride experience.

### SUMMARY OF THE INVENTION

The invention comprises a method and a user interface for reviewing data streams obtained from a fully automated, programmable, and event driven tri-media racing experience system. For clarification, tri-media describes the integration of video, audio and measurement data as a coherent communications media.

One embodiment of the present invention is a method for evaluating the performance of a driver as the driver travels a driving course. Driving performance data, including telemetry data for the vehicle and biotelemetry data for the driver is collected as a driver travels a driving course. The driving performance data is then graphically displayed with a second set of data to allow comparison of the two sets of data. The graphic comparisons include an indicator that shows a current display value of a correlated dimension, such as distance traveled along the driving course, to facilitate comparisons between the sets of data.

In another embodiment, the present invention is a method for providing a racing experience presentation. This method allows for review of video, audio, and telemetry data obtained as a driver travels a driving course. In this method, one of the video streams is designated as a primary video stream for display in a primary video location. Other video streams are designated for synchronous display in secondary locations. The telemetry streams are converted to a graphical display format and also displayed synchronously with the primary video. Additionally, any obtained audio data is played back synchronously with the primary video.

In another embodiment, the present invention provides a user interface for viewing a racing experience presentation. The user interface provides a display format that facilitates review of the racing experience. The user interface includes a primary video display location, secondary video display locations, telemetry display locations, and a control panel for manipulating the data displayed in the display locations.

Various embodiments of the present invention can provide an exciting and informative re-creation of a racecar driving experience; an exciting and informative re-creation for people who wish to immerse themselves in a racecar driving experience; a professional driver training tool to train professional drivers; and, via real-time data analysis, an event driven re-creation of a racecar driving experience.

Further, certain embodiments of the invention can convey supporting contextual and environmental information to enhance, clarify and focus the perception of the content in the re-created experience beyond what point-of-view video recordings of an event could accomplish.

### BRIEF DESCRIPTION OF THE DRAWINGS

These and other more detailed and specific features of the present invention are more fully disclosed in the following specification, reference being had to the accompanying drawings, in which:

FIG. 1 provides a high level systems perspective of an embodiment of an experience-oriented multimedia racing system according to the present invention.

FIG. 2 is a system architecture block diagram illustrating the subsystems in an embodiment of the present invention.

FIG. 3 schematically illustrates the various subsystems and components of an on-vehicle tri-media production system according to an embodiment of the present invention.

FIG. 4 is a functional block diagram depicting a post-production and data dissemination process according to an embodiment of the present invention.

FIG. 5 is an illustration of a tri-media player application as viewed by the consumer. The figure depicts a “Seat Time” playback screen view of a consumer driving experience according to the present invention.

FIG. 6 illustrates a display of a tri-media player application during an “analysis” segment

FIGS. 7a and 7b are flowcharts of a recording method of an experience oriented multimedia racing system according to an embodiment of the present invention.

Similar reference characters denote corresponding features consistently throughout the figures.

### DETAILED DESCRIPTION OF THE PREFERRED EMBODIMENT

In the following description, for purposes of explanation, numerous details are set forth, such as flowcharts and system configurations, in order to provide an understanding of one or more embodiments of the present invention. However, it is and will be apparent to one skilled in the ail that these specific details are not required in order to practice the present invention.

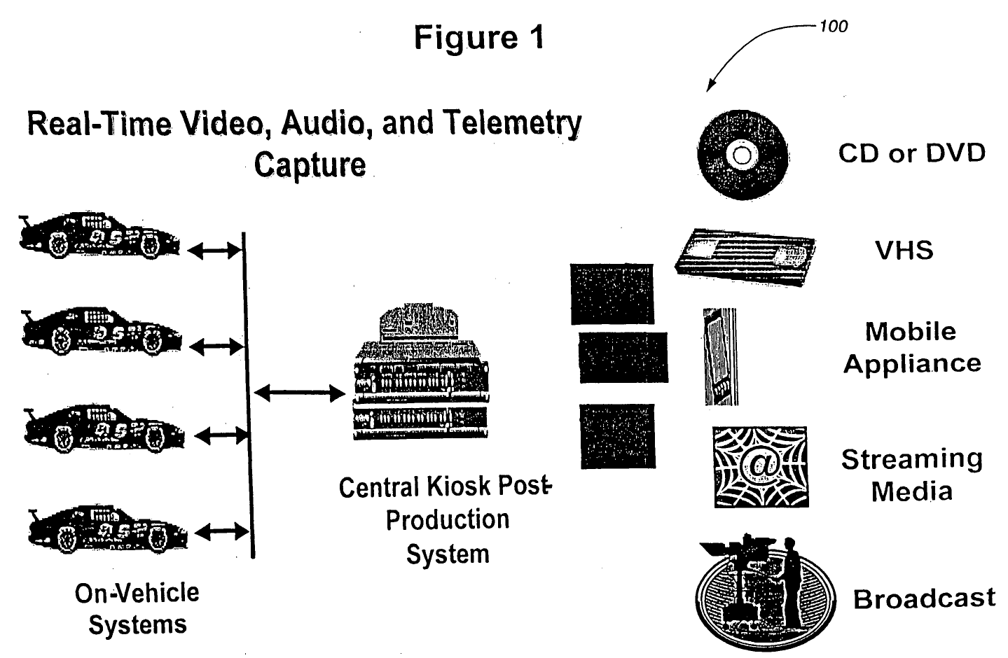

As illustrated in FIG. 1, the present invention is a multimedia racing experience system 100 that captures and processes real-time data from multiple sources and media types. The term tri-media is used to indicate the inclusion of video, audio, and telemetry data. The tri-media data is transformed into a coherent edutainment multimedia presentation that encapsulates and embodies the excitement of a consumer's driving or racing school experience. The multimedia racing experience system 100 facilitates the recording or broadcast of the experience. Recorded experiences are delivered in either fully interactive mode via CD or DVD disc or simple playback mode via VHS or similar tape media. The experiences can also be distributed to consumers via streaming media or broadcast modes.

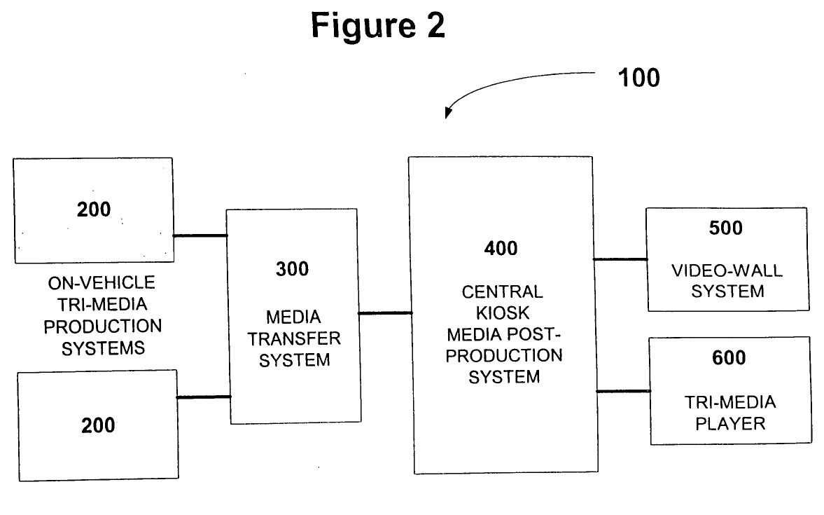

FIG. 2 is a block diagram illustrating an embodiment of a multimedia racing experience system 100. The system includes five subsystems: on-vehicle tri-media production systems 200; media transfer systems 300; central kiosk media post-production system 400; video-wall system 500; and tri-media player systems 600. The features and capabilities of the subsystems are described in detail below.

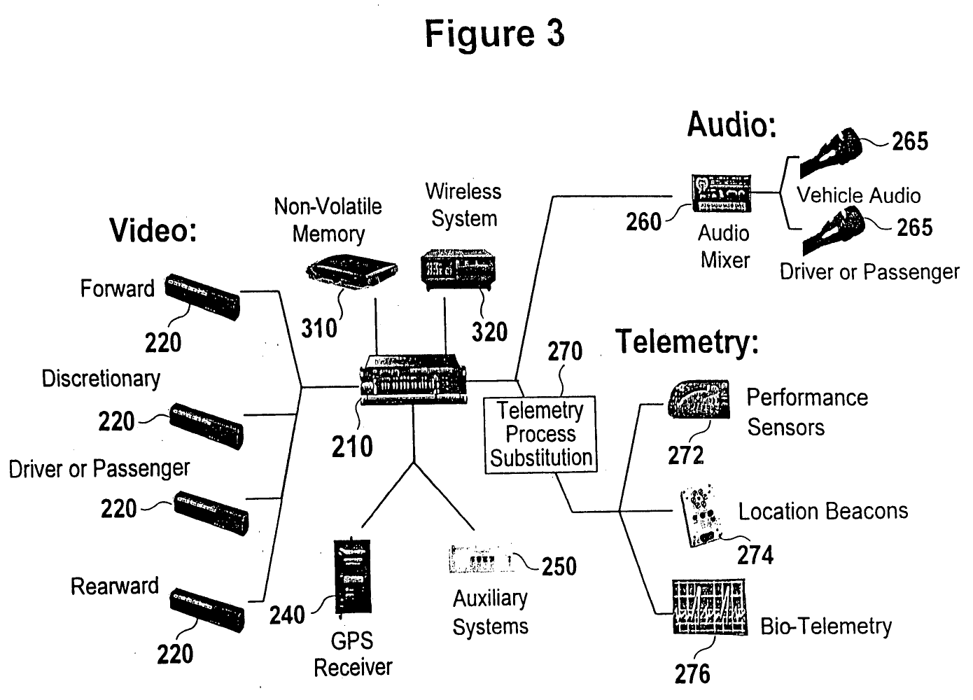

The tri-media data collection process is accomplished via on-vehicle production systems 200. FIG. 3 illustrates the subsystem components for an embodiment of the on-vehicle production system. As illustrated in the figure, a control unit 210 serves as the heart of the on-vehicle production system. All tri-media data collection input devices are connected to the control unit.

Video data is collected by one or more video cameras 220 mounted at various locations on the vehicle. The control unit 210 can also receive additional remote video data feeds via wireless radio frequency transmission from cameras 220 at strategic locations around the track or in the pit area. Camera views and points of installation are configurable to suit the needs of a driving or racing school operator. Although the system may be variously configured, a preferred configuration for an embodiment involving four on-vehicle cameras is as follows. The first on-vehicle camera provides a forward-looking driver's view. The second on-vehicle camera provides a view from the rear of the racecar. The third camera provides a view of the driver or passenger. A fourth on-vehicle camera provides an action view appropriate to the style of racing. For example, photography of the driver's footwell to capture pedal control activity is appropriate for sports car and road racing experiences. An exterior side projecting view of the outer track wall may be preferable for stock car and oval track racing. Additionally, remote cameras are located around the track to provide exterior views, such as a view of the start finish line, a view of the pit area, or views of curves or straightaways on the track. Conventional cameras and radio frequency transmitters, including wireless cameras, may be used in the system. An example of a suitable wireless camera system is the digital wireless camera system available from Thomson Grass Valley of Paris, France. Other suitable cameras are available from Ultrak, Inc. of Lewisville, Tex.

The capture and production of high quality audio data is also a preferred aspect of the invention. Particularly, with the tri-media racing experience system audio data is processed and enhanced for consumer enjoyment and satisfaction, to provide specific performance-oriented information to the consumer. Multiple microphonic devices 265 are placed at strategic locations throughout the racecar. The devices 265 are used to capture key audio data, such as driver and passenger vocals and the vehicle's engine, transmission, and exhaust notes. In an embodiment, the microphonic devices are connected via audio cabling to an audio mixer 260 housed in the on-vehicle control unit 210. The audio mixer 260 includes digital noise filtering and automatic gain control circuitry to maximize effective sound recording in a racecar environment. Remote microphones can also be implemented, by placement in locations such as the pit area or along the track to provide additional audio tracks. These microphones are connected to control unit 210 via radio frequency transmitters. In an embodiment, the tri-media racing experience system includes audio subsystems that isolate specific performance related sounds and filter and mix these to convey coherent sonic information to the consumer. Suitable microphones for use in the racecar are available from Shure Incorporated of Evanston, Ill. Suitable microphones for use in a driver's helmet are available from Gentex Corporation of Carbondale, Pa.

The system may also collect and record real-time biometric data from the vehicle driver or passenger. Biometric data, also referred to herein as biotelemetry data, can be transformed into a biofeedback stream that has both an entertainment value for the casual fan and an educational value for student drivers. The biotelemetric information is preferably collected via non-invasive, skin contact based, pulse oximeter devices (not shown) that gather pulse, respiration rate, and oxygen saturation range (Sp0₂) data from the driver/passenger. The pulse oximeter may be any conventional, commercially available pulse oximeter. The pulse oximeter is connected by cabling to a biotelemetry-processing unit 276 housed in the on-vehicle tri-media control unit 210.

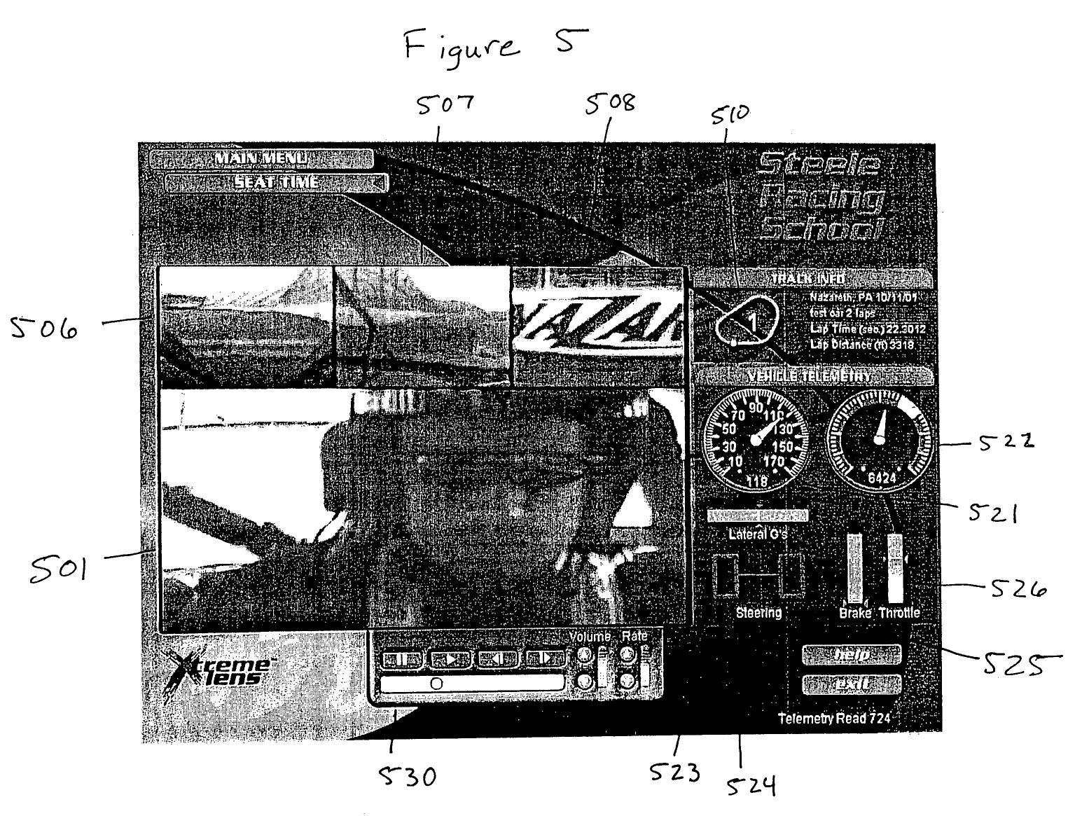

The system also preferably collects real-time vehicle performance telemetry data 272. Multiple sensors (not shown) are strategically placed in the vehicle to capture driver control activities and vehicle handling information. The vehicle telemetry sensors can, for example, monitor wheel-speed, RPM, lateral and longitudinal G-forces, steering angle, throttle position, and brake pedal position. Additionally, track location beacon sensors are used to record lap times and lap counts 274. Track location and beacon sensors may also be used to identify a vehicle's current position on the track. In an embodiment, vehicle performance telemetry and location sensors are connected by cabling to a telemetry processing subsystem 270 housed in the on-vehicle tri-media control unit 210. This information is conveyed on the software player data presentation illustrated in FIG. 5 that is discussed below. Various conventional vehicle telemetry sensors can be used to provide the described vehicle performance telemetry data.

In an embodiment, vendor specific binary telemetry data gathered during vehicle operation is automatically converted, via a program, to standard measurement units. For example, speed data is expressed as miles per hour (mph) and tenths of mph. In an embodiment, each telemetry record has a timestamp that represents the date and time the telemetry record was captured. Using this timestamp, the telemetry data is synchronized with the video start recording mark and a timeline is constructed that spans the start recording mark and video end recording mark. In an embodiment, the timeline has intervals of 200 milliseconds and the telemetry record that is closest to that interval is used for that timeline interval. The converted data elements are then formatted for inclusion in the tri-media presentation. In an embodiment, the converted data elements are formatted into plain text with tabs separating each data element and then written to a file that is part of the image for the tri-media player output media.

One of the features of the tri-media racing experience system 100 is the ability to trigger video switching based on real-time events. FIG. 5 illustrates a screen view of a consumer driving experience that is provided in a playback mode, particularly a “Seat Time” playback screen view. As indicated, the video images are presented in a quadripartite screen format including a primary camera view 501 and three secondary camera views 505, 506, and 507, aligned at the top of the primary view. In an embodiment the selection of which video to display in each of the camera views can be preprogrammed to switch automatically based on real-time analysis of the data derived from performance-sensors and biosensors. For example, in an embodiment the primary camera view 501 focuses on the driver/passenger when the vehicle is at rest or traveling slowly, secondary view 506 displays a forward track camera video, and secondary views 507 and 508 display output from other cameras When the vehicle reaches a predetermined speed as it exits the pit area, the primary view 501 is switched to a forward track camera view while the driver/passenger view is switched to secondary view 506. The camera view selection reverts to the initial state when the vehicle slows to enter the pit area. The primary and secondary camera viewing fields are fully selectable based on style of driving or individual preferences. The on-vehicle production control unit 210 controls the camera view switching process.

Alternatively, a track positioning subsystem provides a means for controlling on-vehicle video switching based on the vehicle's physical location on the track. A plurality of wireless beacon transmitter/receiver pairs (not shown) are used to control the video switching process, which is used to incorporate external trackside camera views of the on-track vehicle. The on-vehicle production system 210 can interpose the external trackside view with any of the on-vehicle camera views. Those skilled in the art will recognize that the switching schemes described here may also be used for selection of audio or telemetry data for inclusion in a tri-media data stream. Suitable beacons include the single channel, 10 channel, or 32 channel beacons available from Pi Research, Inc. of Indianapolis, Ind.

Referring again to FIG. 3, the control unit 210 contains one or more processing units to multiplex and encode the plurality of input data sources. In an embodiment, the control unit 210 includes one or more interconnected computers and an on-vehicle computer server. Suitable computers include single board computers, such as those available from Kontron America of San Diego, Calif. The control unit 210 preferably encodes and multiplexes the input data in real-time to facilitate synchronization of data from the various input sources. The multiplexing and encoding are carried out using standard formats, such as MPEG encoding (for example, MPEG1, MPEG2, MPEG3, or MPEG4). Coherent, synchronized tri-media data streams are output from the control unit for post-production processing via the media transfer system 300 components. The transfer process can be accomplished in various ways. In an embodiment, the transfer is accomplished by use of removable solid-state memory devices 310, such as a conventional flash memory card. In another embodiment, the transfer occurs by wireless radio frequency transmission via transmitter 320. The choice of a method of transfer is typically dictated by customer desires. Systems can be configured to support one or both media transfer modes. In an embodiment, the tri-media data streams are generated in real-time by the on-vehicle control unit 210 and output to the media transfer interface. For on-vehicle systems configured with removable solid-state memory devices 310, the memory device is removed from the control unit 210 and physically transported to the central kiosk media post-production system 400 at the completion of a racing/driving experience. For on-vehicle systems configured with wireless communications subsystems, the real-time tri-media data streams are output from the on-vehicle control unit to a transmitter, such as microwave radio frequency transmitter 320. In an embodiment, the invention makes use of a rooftop antenna designed to support transmission and reception of microwave signals by a vehicle traveling at high-speeds. The electromechanical characteristics of the on-vehicle and stationary antennae were designed to minimize signal loss and interference due to multi-path, Doppler, and pointing error effects. In this embodiment, the microwave radio frequency transmitter 320 makes use of the 5.8 GHz frequency band authorized by the Federal Communications Commission for low-power unlicensed operations. It is anticipated that further iterations of the invention will make use of other frequency bands as appropriate to achieve performance enhancement or meet changing regulatory requirements.

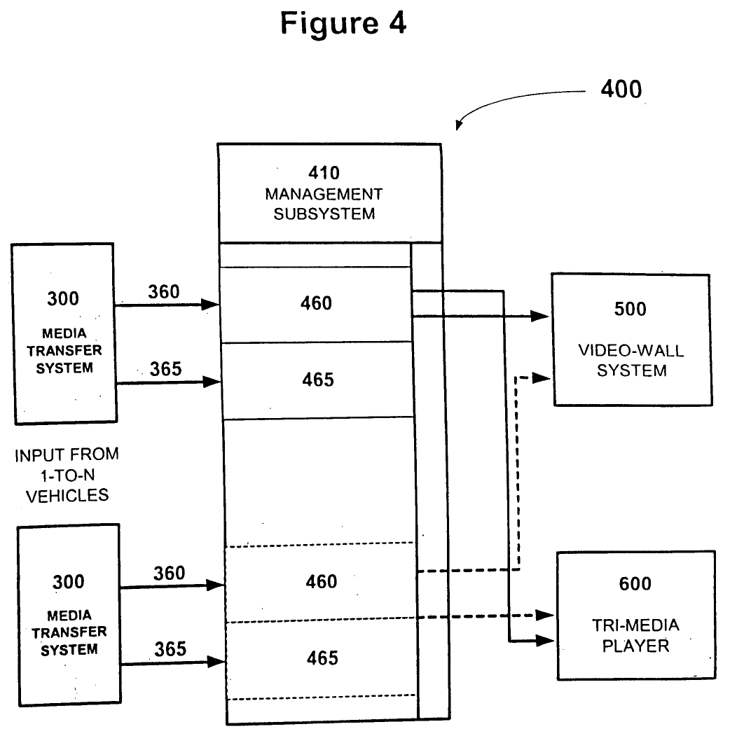

FIG. 4 is a schematic diagram that illustrates an embodiment of a central kiosk-based system 400 and a corresponding tri-media post-production and data dissemination process; The illustrated central kiosk-based system 400 serves as the cornerstone of the post-production process. Preferably, the system is designed for near-autonomous operation in a rugged open-air trackside environment, with system operations being automated and requiring minimal human operational control. Operator interaction can be limited to powering the system on/off, checking system status, and inserting and removing the appropriate tri-media player media, such as CD disks. Various configurations can be provided for interfacing with the operator, such as a conventional computer video display, keyboard and mouse, or a touch screen display unit.

The role of the central kiosk system 400 is to transform and integrate tri-media data streams received from on-vehicle systems 200 with prerecorded edutainment data into an appropriate output media format for consumer usage. As illustrated in FIG. 4, a computer-based management subsystem 410 is used to monitor and control central kiosk post-production system operations. One or more media production computers 460 and 465 perform tri-media data stream processing, including decoding and displaying the tri-media data stream. In an embodiment, media production computers 460 and 465 are workstations configured with software for processing tri-media data streams. The central kiosk system is modularly expandable to support from 1-to-N independently functioning media production computers. The modularly expandable nature of the central kiosk system facilitates concurrent post-production support for multiple on-vehicle systems.

In some embodiments, the central kiosk media production computers 460 and 465 are configured to-support one of two modes of media transfer from the on-vehicle systems. Computers designated 460 in FIG. 4 are configured to support tri-media data stream transfer via solid-state memory devices. In an embodiment the post-production process is initiated by the insertion of the solid-state memory device into a receptacle on the media production computer. The kiosk operator will then be prompted on the kiosk management subsystem display unit to load the appropriate tri-media player output media, such as a CD, DVD, or VHS tape. The data recording process is fully automated. On completion of the recording phase, the kiosk operator will be prompted to remove the output media. The output media is now ready for transfer to the consumer. Examples of displays generated from the data recorded on output media are provided below.

In another embodiment, the central kiosk can be equipped with media production computer subsystems 465 configured to support tri-media data stream collection via wireless radio frequency reception. Microwave reception is facilitated via a modularly expandable antenna array capable of supporting a plurality of real-time on-vehicle tri-media transmissions. The media production computer subsystem 465 includes a microwave receiver and decoder that outputs the real-time tri-media data stream for data recording as described above.

A video-wall system 500 provides an effective edutainment display. The modularly expandable video-wall system contains from 1-to-N display monitors. Nominally, the system is configured with 9 (nine) display monitors arranged in a 3-by-3 pattern. One of the monitors is connected to a DVD or VHS player to display prerecorded edutainment or advertising materials. The remaining monitors are connected to the central kiosk media production computers 460 and 465 to display post-production real-time or playback tri-media data collected from on-vehicle systems 200. Typically, racing school participants and their friends and family members wait for extended periods in-field seating with limited views of the on-track activities. The video-wall system will greatly enhance the entertainment value of the experience.

The final stage of the invention consists of the dissemination of the output product in various consumer media formats, such as CD, DVD, streaming web media, broadcast media, and VHS. In an embodiment, the product will be viewed on a CD or DVD disk via a custom-built tri-media player software application 600. The tri-media player is a software application that enables the captured tri-media data to be treated as a complete and coherent experience for interactive playback by the consumer. The application and tri-media files are delivered to the consumer in various media formats, including CD, DVD, television broadcast, Internet streaming, or similar digital consumer media. A racecar driver or passenger can recreate the experience by viewing synchronized and integrated tri-media information (visual images, audio and telemetric data) of a run on the track.

FIG. 5 illustrates an embodiment of a computer display screen format for tri-media player output during a “seat time” segment. The figure illustrates the real-time integration and synchronization of the video, audio, and telemetry data for a single drive or race. As described above, primary view 501 and secondary views 506, 507, and 508 display video outputs from cameras located either within the vehicle or located remotely around the track. Graphical track image 510 provides a representation of the shape of the track being traveled. Track image 510 may optionally include additional track information as well as an indicator mark for displaying a current track position. Telemetry indicators 521-526 provide information about the current operating parameters of the vehicle. FIG. 5 provides example of a telemetry display including a speedometer 521, a tachometer 522, a G-force indicator 523, a steering angle indicator 524, a brake position indicate 525, and a throttle indicator 526. In other embodiments, the telemetry indicators may, include other vehicle telemetry data or may include biotelemetry data such as the pulse rate or respiration rate for the driver. In addition to the video, track image, and telemetry outputs, the display also includes audio tracks. The audio tracks can include engine and transmission sounds as well as driver or passenger commentary. In embodiments involving CD, DVD, or other digital storage media, playback of the tri-media data is controlled by control panel 530 shown at the bottom of FIG. 5. Control panel 530 allows the viewer to change the volume level, select a portion of the output for playback, and control the rate of playback for the tri-media output.

In addition to the driving experience tri-media data stream, the tri-media player output will contain supplemental edutainment data, such as video clips describing the driving school, racetrack, and racecar. In embodiments where the tri-media information is stored in CD or DVD format, a storyboard format is provided for ease of navigation and viewing. For example, a storyboard could comprise 5 ‘Acts’: Act 1 would contain track history and design; Act 2 would contain information about the driving school-where the tri-media presentation was made; Act 3 would contain pre-ride educational materials; Act 4 would contain the driving experience itself, including multiple views of the drive or race; and Act 5 would contain material regarding follow-on programs at the driving school. The specific content format will be customized to meet the needs of driving schools.

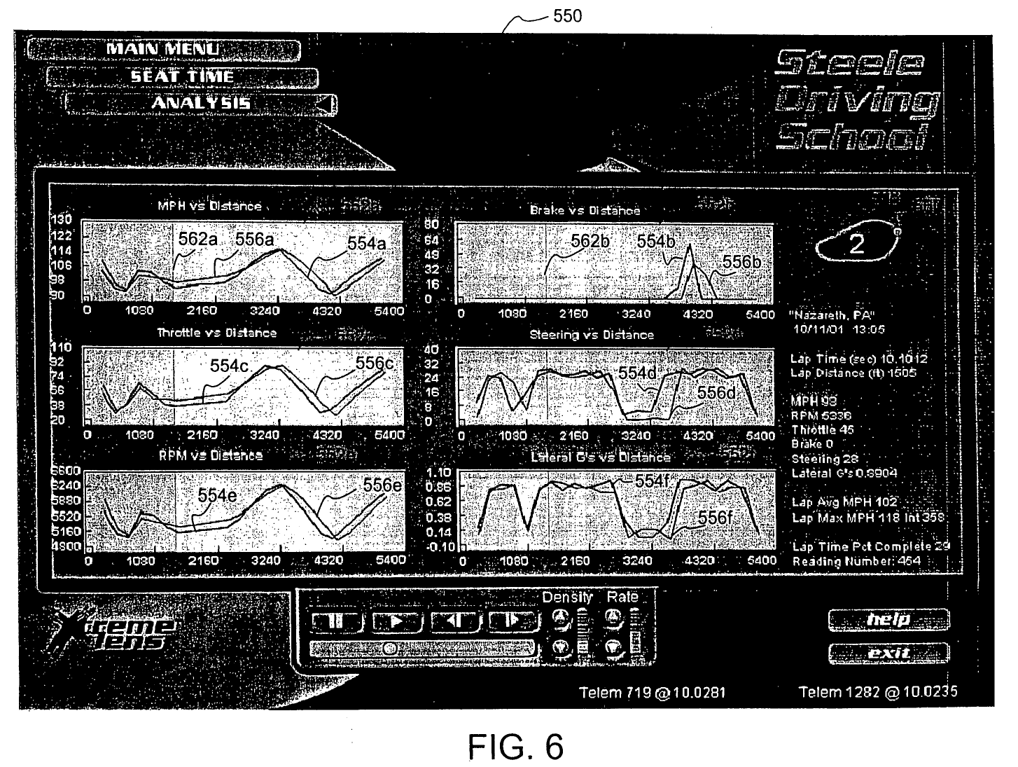

FIG. 6 illustrates a computer display screen 550 of the tri-media player output during an “analysis” segment, where the performance of two drivers is compared side by side. In this embodiment, a statistical comparison between a subject driving experience and a reference are concurrently displayed alongside a graphical track display 558 of the test track. This allows a comparison of the consumer-driver's performance to a reference, according to various criteria and reference types. The shown comparison implements a series of graphs 552a-f that display the comparison criteria as a function of distance. These examples of graphs include MPH v. Distance 552a, Brake v. Distance 552b, Throttle v. Distance 552c, Steering v. Distance 552d, RPM v. Distance 552e, and Lateral G's v. Distance 552f. Alternative criteria may be provided, and the criteria may be displayed as a function of another correleated dimension, such as time. Alternative types of graphs, such as pie graphs or others can also be provided.

Each graph displays information for the subject driver and the reference on the same set of axes for comparison. Specifically, lines 554a-f depict information for the subject driver, and lines 556a-f for the reference. The data used to plot the subject driver lines is obtained from the previously introduced information (e.g. telemetry data) that has been collected for the driving experience. The data used to plot the reference driver lines may be obtained from various sources including measurements of previously driven laps, averages of such measurements, or hypothetical information. The reference may be another driver that drove with the subject driver simultaneously, a past performance by the subject driver, a performance by a known professional driver, or others.

Preferably, a graphical track image 558 is displayed in one location of the analysis display screen 550, with an indicator 560 that travels along the graphical track image 558 synchronized with data updates in the graphs 552a-f, just as is provided with the driving experience functionality of the seat time segment. Among other things, this allows the viewer to easily observe a location on the track corresponding to notable differences or similarities between the subject driving experience and the reference. Preferably, the graphs include a highlight bar (e.g., 562a-b), which moves along the graphs to display a currently updated location along the reference axis.

Specifically, the bar 562a-b or line travels along the reference axis (x-axis, here distance) synchronized to the progression of the indicator 560 along the graphical image of the track. The portion of the graph on one area of the graph (e.g., left) can be displayed in a color that differs from the remaining area of the graph (e.g., right of the line) to further highlight the correlation of the graphs to actual track location. This combination of visual indicators allows a review of the driving experience and comparison to a reference that is tied to the performance on the track in a readily recognizable fashion.

Finally, a playback control allows easy review of and navigation of the driving data. The density bar controls the granularity of the displayed graphical information and the rate bar controls the rate at which the indicator 560 progresses along the track, which allows easier review and comparison to the reference.

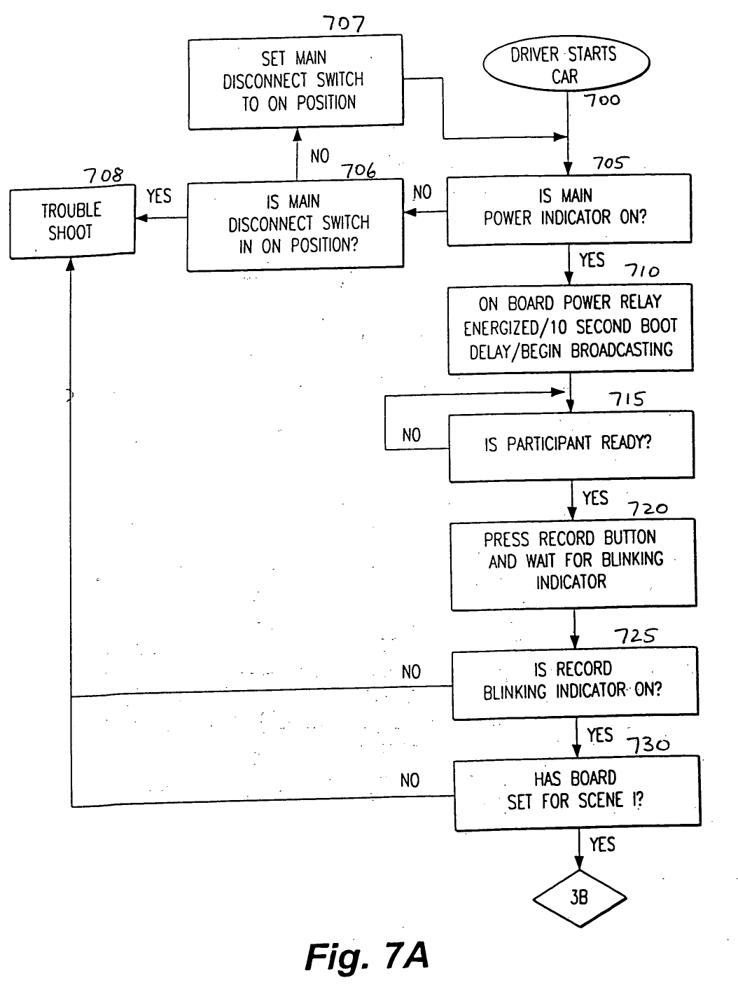

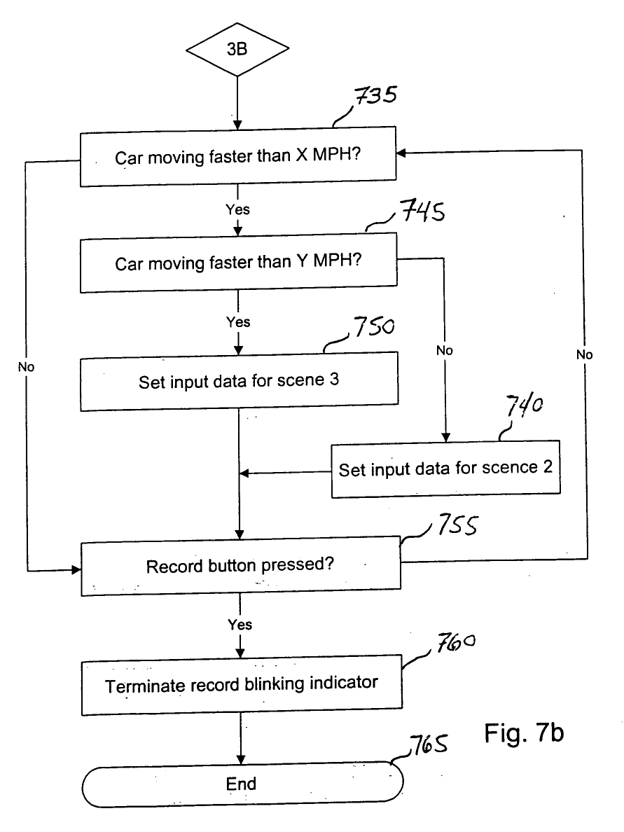

FIGS. 7a and 7b provide a flowchart of the steps involved in recording a tri-media data stream according to an embodiment of the present invention. The process begins when the driver starts the vehicle (700). If the main power indicator is not on (705), the main disconnect switch is checked (706) and activated (707) if necessary, or investigated for further problems (708). Otherwise, the driver waits for the on board systems to power up and become ready for broadcasting (710). After this, once the participant is ready (715), the record button is pressed (720); If the system is working properly (725 and 730), a record indicator will blink and the system will set itself for the first scene or view of the tri-media output. The system will record the input data according to the specifications for the first view until the car reaches a specified speed (735). At this point, the system will identify the parameters for the next scene or view (740) and begin recording the data under this format. Additional speed breakpoints for changing view (745, 750) may be specified, or other telemetry parameters can be used as criteria for changing the output format to a new scene. At the end of the drive, the record button is pressed again (755) to end the recording. This should deactivate the record indicator (760). At this point, the driver can turn off the vehicle (765), which also turns off the tri-media system and ends broadcasting.

It is to be understood that the present invention is not limited to the embodiments described above, but encompasses any and all embodiments within the scope of the following claims.

1-22. (canceled)

23. A method for capturing multiple aspects of a motional experience, for integrating the captured aspects and for formatting said integrated aspects for replay of said motional experience, comprising:
collecting tri-media data related to a motional event, wherein:
said tri-media data comprises separable and at least one-dimensionally synchronized audio, video associated with a user's experience with said motional event, and sensor data related to a conveyance means associated with said user during said motional event;
front-end processing of said tri-media data, creating integrated tri-media data; and
back-end processing of said integrated tri-media data for creating an event record for viewing.

24. The method of claim 23 wherein said motional event is operating a race car in a performance evaluated effort.

25. The method of claim 23 wherein said conveyance means is a race car traversing a track.

26. The method of claim 23, wherein said video and audio data are associated with said user while said user is associated with said conveyance means.

27. The method of claim 26, wherein said video and audio data are also associated with an environment surrounding said conveyance means while said user is associated with said conveyance means.

28. The method of claim 23, wherein said motional data is selected from the group comprising:
temporal position, track position, distance traveled, speed, RPMs, uni-directional G-force acceleration, tri-axial G-force acceleration, throttle position, steering angle, brake position and data derived therefrom.

29. The method of claim 23, wherein said sensor data also includes biological data associated with said user while said user is associated with said conveyance means during said motional event, wherein said biological data is selected from the group comprising:
heart rate, respiration rate, blood pressure, adrenalin production, perspiration production and bodily deformations and displacements.

30. The method of claim 23,.wherein said one-dimensional synchronization is based on timestamping of said tri-media data.

31. The method of claim 23, wherein said collecting comprises selecting for receipt portions of said one-dimensional, synchronized audio and video data based upon at least one instantaneous value of said sensor data.

32. The method of claim 23, wherein said front-end processing comprises transforming, converting, rendering, encoding and integrating said tri-media data.

33. The method of claim 32, wherein said encoding comprises formatting said separable tri-media data into separable encoded streams of audio, video, motional and biological data comprising encoded data.

34. The method of claim 32, wherein said rendering comprises duplicating and representing at least parts of said sensor data into graphic representations of sensor data prior to said encoding of said graphic representations of sensor data into rendered data.

35. The method of claim 32, wherein said integrating comprises compiling said transformed, converted, rendered and encoded data into configurable and presentable data streams.

36. The method of claim 23, wherein said back-end processing comprises transmitting and presenting said integrated tri-media data.

37. The method of claim 36, wherein said presenting comprises displaying said integrated tri-media data on monitors viewable in real time.

38. The method of claim 36, wherein said presenting comprises displaying said integrated tri-media data on monitors viewable subsequent to said motional event.

39. The method of claim 23, further comprising storing said integrated tri-media data in association with a dispensable medium for playback on a playback means.

40. The method of claim 39, further comprising dispensing said integrated data via said dispensable medium.

41. The method of claim 39, wherein said dispensable medium is selected from the group comprising a CD disc, a DVD disc, a Mini-DVD disc, a VHS tape and the Internet.

42. The method of claim 39, wherein said playback means comprises one of a CD player, a DVD player, a Mini-DVD player, a VHS player, an Internet delivery service and a motional event simulator.

43. The method of claim 40, wherein said dispensing comprises delivering said dispensable medium from a kiosk subsequent to purchase of said dispensable medium.

44. The method of claim 23, further comprising reviewing said integrated tri-media data for education or entertainment.

45. The method of claim 44, wherein said reviewing comprises viewing said integrated data on an interactive basis.

46. The method of claim 44, wherein said reviewing comprises one of the group of: providing a racing experience presentation, viewing a racing experience presentation and evaluating the performance of a racing experience.

47. The method of claim 23, wherein said front-end processing may be performed, at least in part, on devices physically associated with said conveyance means.

48. The method of claim 23, wherein said front-end processing may be performed, at least in part, on devices not physically associated with said conveyance means.

49. A method for capturing multiple aspects of a driving experience including a driver and a vehicle, for integrating the captured aspects and for formatting said integrated aspects for replay of said driving experience, comprising:
collecting tri-media data related to a driving event, comprising synchronized video associated with said driver, video associated with said vehicle, video associated with the path of travel of said vehicle and audio synchronized with said video, and sensor data related to said vehicle synchronized with said audio and video, wherein all of said tri-media data is synchronized with the positional location of said vehicle along said path of travel during said driving experience;
front-end processing of said tri-media data, creating integrated tri-media data, including transforming, converting, rendering, encoding and integrating said tri-media data, including formatting said separable tri-media data into encoded streams of audio, video, and sensor data, comprising encoded data, and
back-end processing of said integrated tri-media data including transmitting and presenting said integrated tri-media data for creating an event record, for viewing, including preparation of said integrated tri-media data for display on a monitor viewable subsequent to said driving event, wherein at least two different ones of said collected videos are simultaneously displayed synchronized with the play back of said collected audio and with the simultaneous display of at least a portion of said collected sensor data correlated with said synchronized positional location of said vehicle.

50. The method of claim 49, said tri-media data further including video associated with an environment surrounding said vehicle during said driving experience.

51. The method of claim 49, wherein said sensor data is selected from the group comprising:
temporal position, track position, distance traveled, speed, RPMs, uni-directional G-force acceleration, tri-axial G-force acceleration, throttle position, steering angle, brake position and data derived therefrom.

52. The method of claim 49, wherein said sensor data also includes biological data associated with said driver during said driving experience, wherein said biological data is selected from the group comprising:
heart rate, respiration rate, blood pressure, adrenalin production, perspiration production and bodily deformations and displacements.

53. The method of claim 49, wherein said presenting includes displaying said integrated tri-media data on monitors viewable in real time.

54. The method of claim 49, further comprising storing said integrated tri-media data in association with a dispensable medium for playback on a playback means.

55. The method of claim 54, further comprising dispensing said integrated data via said dispensable medium.

56. The method of claim 55, wherein said dispensing comprises delivering said dispensable medium from a kiosk subsequent to purchase of said dispensable medium.

57. The method of claim 49, further comprising reviewing said integrated tri-media data on an interactive basis for education or entertainment, including reviewing said driving experience and evaluating the performance of said driving event.
